(19) United States
(12) Patent Application Publication
(10) Pub. No.: US 2005/0259964 A1
(43) Pub. Date: Nov. 24, 2005

(54) Information reproduction apparatus, information reproduction method, information reproduction program, and information recording medium having the program recorded thereon

(75) Inventors: Masashi Takano, Kawagoe-shi (JP); Yuichi Kimikawa, Kawagoe-shi (JP); Taketo Fushimi, Kawagoe-shi (JP); Teruo Takahashi, Kawagoe-shi (JP); Kazuo Kita, Kawagoe-shi (JP); Yuichi Yoshida, Kawagoe-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 11/086,669

(22) Filed: Mar. 23, 2005

(30) Foreign Application Priority Data
Mar. 24, 2004 (JP) P2004-87220

(51) Int. Cl. H04N 5/76

(52) U.S. Cl. 386/94; 360/60; 380/201

(57) ABSTRACT

There is disclosed an information reproduction apparatus (P) which reproduces music information recorded on a recording medium (DK) wherein the apparatus (P) has a CPU (14) which inhibits reproduction of music information recorded in compressed form based on a preset quality benchmark (e.g., a bit rate) for a sound quality of music information. The information reproduction apparatus (P) may further includes an operation section (15) used to set a quality range indicated by the quality benchmark, on a basis of which music information is inhibited from being reproduced. Using the apparatus, information recorded in a recording medium as a compressed file is reproduced without causing discomfort to a user.

### BACKGROUND OF THE INVENTION

1. Field of the Invention

This invention relates to an information reproduction apparatus, information reproduction method, information reproduction program, and information recording medium for reproducing recorded information.

2. Description of the Related Art

To effectively use a recording medium such as a CD (compact disc) , there is known a technique for compressing information (e.g., music information or image information) in recording the information As an example of a technique for compressing and recording such information and reproducing the compressed information, there is proposed a recording and reproduction apparatus with a simple arrangement which allows effective use of a recording medium, as shown in JP2003-283998A.

A standard bit rate (expressed in, e.g., bps (bits per second)) for recording information in compressed form on a recording medium is unspecified. Files are created and recorded on recording media at various bit rates.

Although a decrease in bit rate saves space occupied by a file of a recording medium, it causes a significant degradation in data, thereby lowering a quality of information (sound quality or image quality). Depending on a bit rate at which a file is recorded, reproduced information of the file may have a poor quality, and a user of the file and a reproduction apparatus which reproduces the file may feel discomfort with the poor quality.

### SUMMARY OF THE INVENTION

Under these circumstances, this invention has as its object to provide an information reproduction apparatus and information reproduction method which allow a user of a recording medium having a compressed file as described above recorded thereon to reproduce information without feeling discomfort, a program used by the apparatus and method to reproduce information, and a recording medium having the program recorded thereon.

To achieve the object, according to a first aspect of the present invention, there is provided an information reproduction apparatus which reproduces information recorded on a recording medium, characterized by comprising a reproduction inhibition device which inhibits reproduction of the information recorded in compressed form based on a preset quality benchmark for a quality of the information.

To achieve the object, according to a second aspect of the present invention, there is provided an information reproduction method for reproducing information recorded or a recording medium, characterized by comprising a reproduction inhibition step of inhibiting reproduction of the information recorded in compressed form based on a preset quality benchmark for a quality of the information.

To achieve the object, according to a third aspect of the present invention, there is provided an information reproduction program characterized by causing a computer included in an information reproduction apparatus which reproduces information recorded on a recording medium to function as a reproduction inhibition device which inhibits reproduction of the information recorded in compressed form based on a preset quality benchmark for a quality of the information.

To achieve the object, according to a fourth aspect of the present invention, there is provided an information recording medium characterized by having an information reproduction program recorded thereon so as to be readable by a computer included in an information reproduction apparatus which reproduces information recorded on a recording medium, the program causing the computer to function as a reproduction inhibition device which inhibits reproduction of the information recorded in compressed form based on a preset quality benchmark for a quality of the information.

### BRIEF DESCRIPTION OF THE DRAWINGS

FIG. 1 is a block diagram showing a schematic arrangement of a CD reproduction apparatus according to an embodiment of a present invention;

FIGS. 2A to 2C are charts showing a data structure of a CD medium to be reproduced by the CD reproduction apparatus according to the embodiment of the present invention; and

FIG. 3 is a flowchart showing reproduction processing operation in the CD reproduction apparatus according to the embodiment of the present invention.

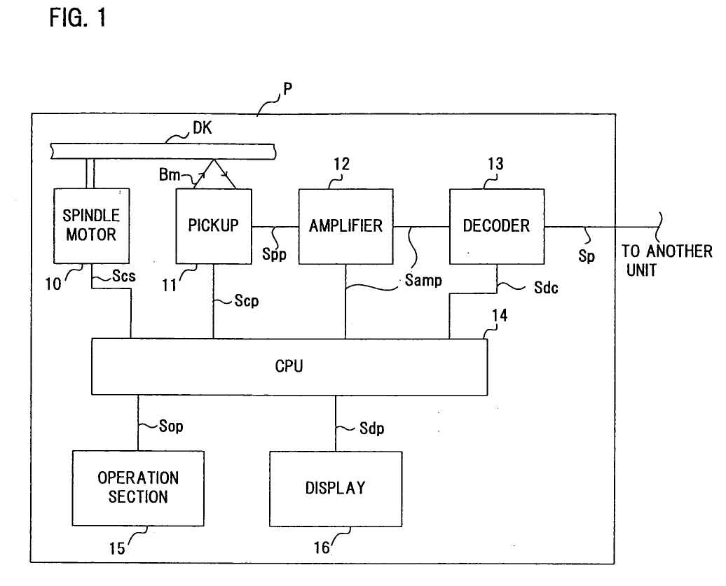

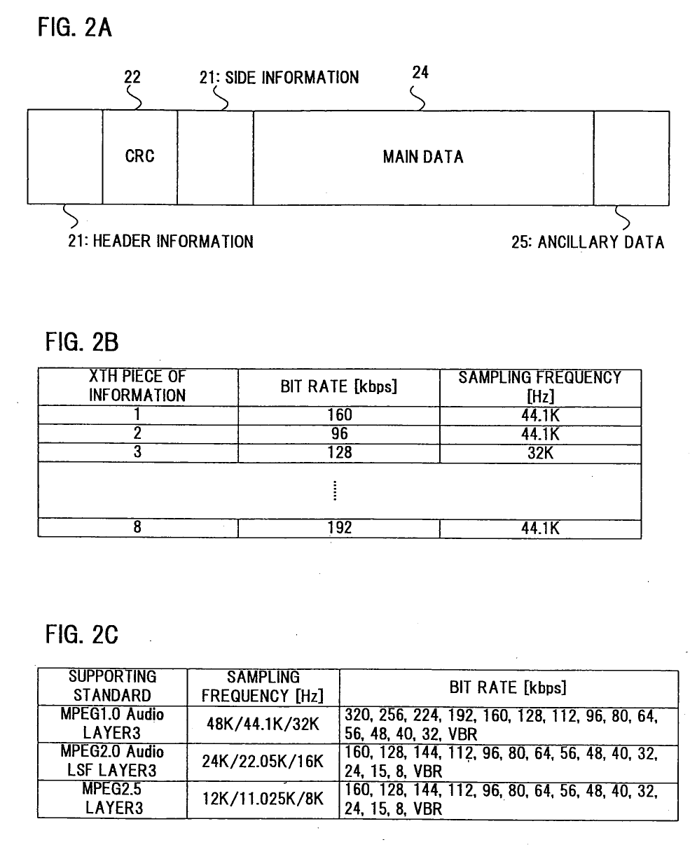

Arabic numerals and Symbols shown in these FIGS. 1 and 2A refer to the following items, respectively: 10: spindle motor; 11: pickup; 12: amplifier; 13: decoder; 14: CPU; 15: operation section; 16: display; 21: header information; 23: side information; 24: main data; 25: ancillary data; P: CD reproduction apparatus; DK: CD medium; and BM: light beam.

### DETAILED DESCRIPTION OF THE PREFERRED EMBODIMENTS

An embodiment of a present invention will be described below with reference to accompanying drawings.

This embodiment will explain a case wherein a CD reproduction apparatus is used as an information reproduction apparatus of the present invention, and a CD medium having music information recorded thereon is used as a recording medium. The music information recorded on the CD medium of this embodiment is one compressed in MP3 (MPEG Audio LAYER3) format. This embodiment is not intended to limit the present invention and can be arbitrarily changed within a technical idea of the present invention.

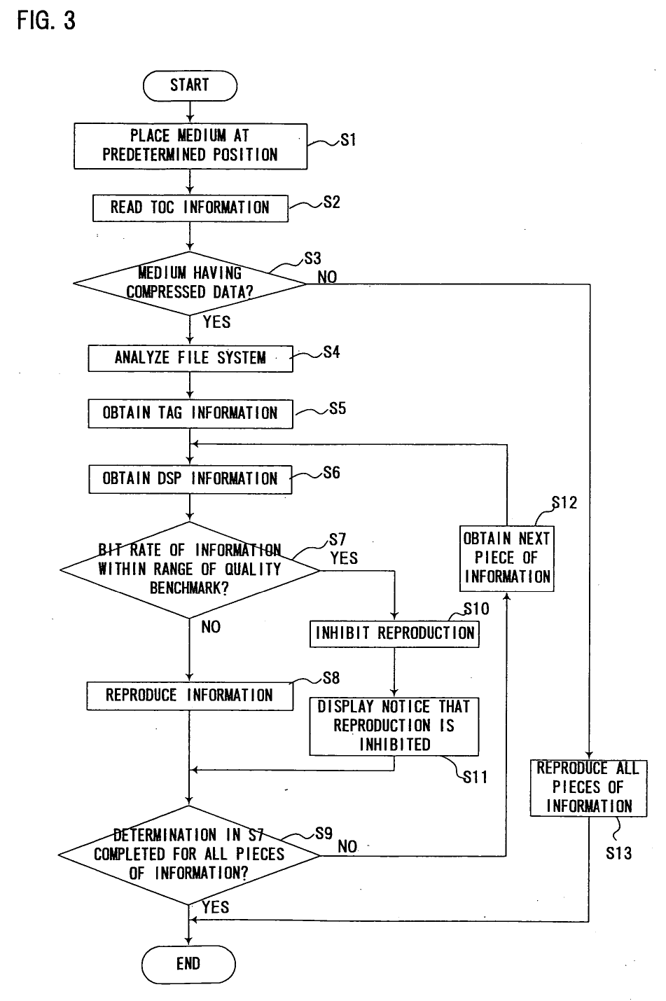

FIG. 1 is a block diagram showing a schematic arrangement of a CD reproduction apparatus of this embodiment; FIGS. 2A to 2C, charts showing a data structure of the CD medium of this embodiment; and FIG. 3, a flowchart of a CD reproduction method of this embodiment.

The arrangement of the CD reproduction apparatus of this embodiment will be described with reference to FIG. 1.

As shown in FIG. 1, a CD reproduction apparatus P according to this embodiment comprises a spindle motor 10 to which a CD medium DK is rotatably fixed, a pickup 11, an amplifier 12, decoder 13, a CPU (central processing unit) 14, an operation section 15, and a display 16.

The CPU 14 functions as a reproduction inhibition device of the present invention and also functions as a reading device and comparison device. The operation section 15 functions as a setting device of the present invention, and the display 16 functions as a notification device of the present invention.

In this arrangement, the spindle motor 10 rotates the CD medium DK at a rotational speed indicated by a spindle servo control signal Scs from the CPU 14. The rotational speed of the spindle motor 10 varies at least from about 680 to about 1,400 rpm, depending on a position of the pickup 11.

The pickup 11 irradiates the CD medium DK with a light beam Bm of constant intensity for information reproduction in accordance with a pickup control signal Scp from the CPU 14. The pickup 11 generates a detection signal Spp corresponding to music information recorded on the CD medium DK based on the light beam Bm reflected from the CD medium DK and outputs it to the amplifier 12.

With this operation, the amplifier 12 amplifies the detection signal Spp by a preset amplification factor and outputs the resulting signal as an amplified signal Samp to the decoder 13. Out of the amplified signal Samp, the amplifier 12 also outputs, to the CPU 14, a signal related to information indicating a quality of the music information on the CD medium DK and a signal related to necessary information.

In a given case, in accordance with a control signal Sdc from the CPU 14, the decoder 13 subjects the amplified signal Samp to preset decoding and outputs the decoded signal as music information Sp to another unit, a speaker unit.

Information of a sound quality range indicated by a quality benchmark, which is input using the operation section 15 (to be described later) and on a basis of which a user inhibits reproduction, is supplied to the CPU 14.

The CPU 14 obtains the signal related to the information indicating a sound quality of the music information on the CD medium DK, out of the amplified signal Samp from the amplifier 12. The CPU 14 compares the sound quality range indicated by the quality benchmark input by the user with the information indicating the sound quality of the music information on the CD medium DR. If the sound quality of the music information on the CD medium DK falls within the sound quality range indicated by the quality benchmark input by the user, the CPU 14 inhibits reproduction of the music information. On the other hand, if the sound quality of the music information on the CD medium DK falls outside the sound quality range indicated by the quality benchmark input by the user, the CPU 14 permits reproduction of the music information.

When the CPU 14 inhibits reproduction of music information, it outputs the control signal Sdc to the decoder 13, does not subject the amplified signal Samp to decoding, and does not permit the speaker to output the music information Sp. When the CPU 14 permits reproduction of music information, it outputs the control signal Sdc to the decoder 13 and permits the speaker to output the music information Sp in the above-described manner.

If the CPU 14 determines, based on quality information indicating whether music information is compressed, that music information recorded on the CD medium DK is not compressed, it deactivates the function of inhibiting reproduction of music information. If a sound quality (e.g., a standard) of music information which the CD reproduction apparatus P can target for reproduction is preset, and a sound quality of the music information recorded on the CD medium DK falls outside the sound quality of music information which the CD reproduction apparatus P can target for reproduction, the CPU 14 inhibits reproduction of the music information.

The CPU 14 outputs the spindle servo control signal Scs indicating a rotational speed of the CD medium DK to the spindle motor 10 in order to control the rotational speed of the spindle motor 10. The CPU 14 also outputs the pickup control signal Scp to the pickup 11 in order to control, e.g., a position of the pickup 11 and an irradiation amount of the light beam Bm in irradiation of the pickup 11 with the light beam Bm.

The operation section 15 is used and operated by a user to cause the components to operate as the CD reproduction apparatus P. The operation section 15 generates an operation signal Sop corresponding to the user's operation and outputs it to the CPU 14. The CPU 14 controls the components constituting the CD reproduction apparatus P in accordance with the operation signal Sop. The operation section 15 is particularly used by the user to set a quality range indicated by a quality benchmark for music information on a basis of which the CPU 14 inhibits reproduction

The display 16 comprises, e.g., a liquid crystal display and displays an operating state of the CD reproduction apparatus P and the like in accordance with a display signal Sdp output from the CPU 14. The display 16 notifies the user that the CPU 14 inhibits reproduction of a piece of music information by displaying a notice to that effect.

The CD medium DK, on which music information to be reproduced by the CD reproduction apparatus P according to this embodiment is recorded, will be described with reference to FIGS. 2A-2C.

FIG. 2A shows an example of a data structure of the CD medium DK. The CD medium DK contains music information compressed in MP3 format.

In the CD medium DK, an MP3 bit stream is composed of header information 21, CRC (cyclic redundancy check) 22 of the header information 21, side information 23, main data 24, and ancillary data 25.

The header information 21 includes TOC (table of contents) information, version information, a layer, a bit rate indicating a sound quality of the main data, a sampling frequency indicating the sound quality of the main data, a channel mode, an emphasis, and the like.

The TOC information includes a quality benchmark indicating whether the music information on the CD medium DK is compressed. The bit rate is a numerical value representing an amount of data (bit count) which can be sent/received in one second and is expressed in kbps. The sampling frequency is a numerical value representing how many times conversion from an analog signal to a digital signal (A/D conversion) is performed in one second and is expressed in Hz. Information including the bit rate and sampling frequency will be referred to as DSP information hereinafter.

The CRC 22 includes information to check whether data is correctly read and written. The CRC 22 protects the header information from errors. The side information 23 is used to decode the main data 24. The main data 24 includes files into which a piece of music information is divided A data size of the main data 24 is known by a version, bit rate, and sampling frequency of the piece of music information.

FIG. 2B shows an example of an order of pieces of music information recorded on the CD medium DK and bit rates and sampling frequencies of the pieces of music information. More specifically, first to eighth pieces of music information and pieces of DSP information for them are recorded, as shown in FIG. 2B.

FIG. 2C shows, for reference, sampling frequencies and bit rates supported by MP3 standards, MPEG1.0 Audio LAYER3, MPEG2.0 Audio LSF LAYER3, and MPEG2.5 LAYER3. A word “VBR” in a bit rate field stands for Variable Bit Rate. In the case of VBR, each bit rate is adjusted to information to be compressed to maintain a quality of the information. If bit rates are VBRs, an average value of the bit rates may be calculated and recorded on the CD medium DK. Alternatively, the average value of the bit rates may be calculated when the CD reproduction apparatus P reads the pieces of information on the CD medium and may be stored in a storage section (not shown). The CPU 14 uses the bit rates and sampling frequencies to determine whether to inhibit reproduction.

A bit rate of about 128 kbps is a CD-standard sound quality. A sound quality improves with an increasing bit rate, and it deteriorates with a decreasing bit rate.

Operation according to the present invention to be performed in the CD reproduction apparatus P will be described with reference to FIG. 3.

FIG. 3 is a flowchart showing operation of reproducing files recorded on the CD medium DK in the CD reproduction apparatus P. This process corresponds to a case wherein the CD medium DK is placed in the CD reproduction apparatus P shown in FIG. 1, and the pieces of music information recorded on the CD medium DK are reproduced by the speaker unit. At this time, as a sound quality range indicated by a quality benchmark, “a bit rate range less than 128 kbps” is preset. Reproduction of a piece of information with a sound quality within this range is inhibited.

First, the CPU 14 recognizes that the CD medium DK is placed in a predetermined medium installation section connected to the spindle motor 10 (step S1). The CPU 14 causes the spindle motor 10 to rotate the CD medium DK and reads TOC information from the amplified signal Samp having passed through the pickup 11 and amplifier 12 (step S2). The CPU 14 determines from a quality benchmark included in the TOC information whether the pieces of music information on the CD medium DK are recorded in compressed form (step S3).

At this time, the pieces of information on the CD medium DK are recorded in compressed form, the CPU 14 determines that the pieces of information are recorded in compressed form (YES in step S3). Then, the CPU 14 analyzes a file system of the CD medium DK (step S4), obtains tag information for the entire CD medium DK (step S5), and further obtains DSP information of the first piece of music information (step S6). After that, the CPU 14 determines whether a bit rate of 160 kbps included in the DSP information falls within the sound quality range indicated by the preset quality benchmark, i.e., is less than 128 kbps (step S7).

Since the bit rate of the first piece of information on the CD medium DK falls outside the sound quality range indicated by the preset quality benchmark, the CPU 14 determines to that effect (NO in step S7) and reproduces the first piece of information (step S8). Then, the CPU 14 determines whether the determination in step S7 is completed for all pieces of music information on the CD medium DK (step S9).

Since the determination is not completed for the second and subsequent pieces of music information of the medium, the CPU 14 determines to that effect (NO in step S9). The CPU 14 obtains a next piece, i.e, the second piece of music information (step S12) and subjects it to the process in step S6.

The CPU 14 determines whether a bit rate of 96 kbps included in DSP information of the second piece of music information falls within the sound quality range indicated by the preset quality benchmark, i.e., is less than 128 kbps (step S7).

At this time, since the bit rate of the second piece of music information on the CD medium DK falls within the sound quality range indicated by the preset quality benchmark, the CPU 14 determines to that effect (YES in step S7). The CPU 14 inhibits reproduction of the second piece of music information (step S10) and causes the display 16 to display a notice that reproduction of the second piece of music information is inhibited (step S11). Then, the CPU 14 determines whether the determination in step S7 is completed for all the pieces of information of the medium (step S9).

Since the determination is not completed for the third and subsequent pieces of information of the medium, the CPU 14 determines to that effect (NO in step S9). The CPU 14 obtains a next piece, i.e., the third piece of music information (step S12) and subjects it to the process in step S6.

As described above, the processes and determinations in steps S6 to S12 are repeated for the third and subsequent pieces of music information. The CPU 14 determines whether a bit rate of 192 kbps included in DSP information of the eighth piece of music information, which is a last piece of information on the CD medium DK, falls within the sound quality range indicated by the preset quality benchmark, i.e., is less than 128 kbps (step S7).

At this time, since the bit rate of the eighth piece of music information on the CD medium DK falls outside the sound quality range indicated by the preset quality benchmark, the CPU 14 determines to that effect (NO in step S7) and reproduces the eighth piece of music information (step S8). Then, the CPU 14 determines whether the determination in step S7 is completed for all the pieces of music information on the CD medium DK (step S9).

Since the determination in step S7 is completed for all the pieces of music information on the CD medium DK, the CPU 14 determines to that effect (YES in step S9) and ends the operation.

On the other hand, if the pieces of music information on the CD medium DK ate not compressed in step S3, the CPU 14 determines from the quality benchmark included in the TOC information that the pieces of music information are not recorded in compressed form (NO in step S3). The CPU 14 reproduces all the pieces of music information (step S13) and ends the operation.

Modifications of the embodiment will be described next.

Although the CD medium DK has been taken as an example of a recording medium, the recording medium is not limited to this. The recording medium may be a DVD (digital versatile disc) medium, an MD (mini disc) medium, a hard disc medium, a flexible disc medium, or a memory card such as CompactFlash®, SmartMedia®, Memory Stick®, SD Card®, or xD-Picture Card®, and various recording media may be used. These recording media may be write-once ones or ones which can be erased and rewritten. In the embodiment, the CD reproduction apparatus P has been explained as an information reproduction apparatus. However, the information reproduction apparatus is not limited to this. For example, a CD recording and reproduction apparatus which can record data on the CD medium DK may be used.

Although information recorded on the CD medium DK has been explained as music information, the information is not limited to this. For example, the information recorded on the recording medium may be at least one of voice and image information. Accordingly, the other unit, to which information is output from the decoder 13, is not limited to the speaker unit described in the embodiment and may be a display unit such as a display or a TV receiver, depending on information to be output.

Music information compressed in MP3 format has been explained as an example of information recorded in compressed form. However, a compression method is not limited to this, and various compression methods can be used. More specifically, music information can be compressed in AAC (advanced audio coding) format; voice and moving image information, in one of MPEG (moving picture experts group) 1 to MPEG4 formats; and still image information, in JPEG (joint photographic experts group) format

A bit rate related to a sound quality has been explained as an information quality recorded on a recording medium which is used as a reference for determining whether to inhibit reproduction. However, the information quality is not limited to this. A sampling frequency and other information qualities related to the sound quality may be used. These information qualities may include one of the bit rate and the sampling frequency or both of them as a reference. For example, setting may be so made as to reproduce only information with a bit rate equal to or more than 128 kbps and a sampling frequency of 44.1 K.

In the embodiment, “a bit rate range less than 128 kbps” is specified as a sound quality range indicated by a quality benchmark. This value can be adequately changed using the operation section 15 to suit preferences of a user. The CD reproduction apparatus P itself may be so preset as to inhibit reproduction of information if “a bit rate of the information is less than 128 kbps” and may be arranged such that the user can set again the sound quality range indicated by the quality benchmark, as needed.

If, e.g., music information files and interview voice information files are mingled together in a recording medium, a quality benchmark A between a quality for a music information file and that for an interview voice information file can be used to set a sound quality range indicated by a preset quality benchmark. To reproduce only music information, the sound quality range indicated by the quality benchmark is so set as to inhibit reproduction of information with a quality below the quality benchmark A. On the other hand, to reproduce only interview voice information, the sound quality range can be so set as to inhibit reproduction of information with a quality within or above the quality benchmark A. The CPU 14 may automatically make these settings in accordance with an instruction input by a user using the operation section 15.

If a quality of information which the CD reproduction apparatus P can target for reproduction (quality benchmark) is preset, as shown in FIG. 2C, the CPU 14 can inhibit reproduction of information with a quality other than the preset quality benchmark. In this case, reproduction of information with a quality (e.g., a bit rate of 134 kbps) other than the preset quality (in the case of MPEG1.0 Audio LAYER3, a sampling frequency of 48, 44.1 or 32 KHz, or a bit rate of 320, 256, 224, 192, 160, 128, 112, 96, 80, 64, 56, 48, 40 or 32 kbps) is inhibited before step S7 of the flowchart in FIG. 3.

An aspect has been described wherein the CPU 14 of the CD reproduction apparatus P inhibits reproduction of information by not decoding the amplified signal Samp related to the information inhibited from being reproduced. Control for reproduction inhibition, however, is not limited to this operation. For example, the CPU 14 may control the pickup 11 not to irradiate, with the light beam Bm, a data area in which information inhibited from being reproduced is recorded or not to output the detection signal Spp corresponding to the information inhibited from being reproduced to the amplifier 12. Alternatively, the CPU 14 may control the amplifier 12 not to amplify the detection signal Spp corresponding to the information inhibited from being reproduced or not to output the amplified signal Samp corresponding to the information inhibited from being reproduced to the decoder 13. Alternatively, the CPU 14 may control the decoder 13 to convert the amplified signal Samp into the music information Sp by decoding and may control the information not to be output to the speaker.

In the embodiment, a notice that reproduction of music information is inhibited is given by being displayed on the display 16 of the CD reproduction apparatus P serving as the notification device of the present invention. The present invention, however, is not limited to this arrangement. For example, the notice that reproduction of music information is inhibited may be given by voice using the speaker unit (not shown) serving as the notification device of the present invention.

In the embodiment, the CPU 14 reads a bit rate indicating a sound quality recorded on a recording medium and inhibits reproduction of music information based on a quality benchmark. A function of the CPU 14 serving as a reproduction inhibition device is not limited to this. For example, the CPU 14 may read a sound quality of music information by reading the main data 24 of the music information from a recording medium and analyzing it and may inhibit reproduction of the music information based on the quality benchmark.

A microcomputer can function as the CPU 14 according to the embodiment by reading and executing a program corresponding to the flowchart shown in FIG. 3 which is previously recorded on an information recording medium such a flexible disc or hard disc or which is obtained through a network such as an Internet and is recorded on the information recording medium.

The CD reproduction apparatus P of this embodiment described above is a CD reproduction apparatus which reproduces information recorded on the CD medium DK and is characterized by having the CPU 14 as a reproduction inhibition device which inhibits reproduction of music information recorded in compressed form based on a preset quality benchmark for a sound quality of music information.

Since the CD reproduction apparatus P inhibits reproduction of music information based on the quality benchmark, it can reproduce music information while automatically skipping a piece of information with a quality which a user does not want to target for reproduction. For this reason, the user is free from discomfort caused by seeing or hearing reproduced music information with a poor sound quality. If a piece of music information with a poor sound quality is recorded on the CD medium DK, the user need not skip the piece of music information and operate to reproduce other pieces of music information. The CD reproduction apparatus P is excellent in user convenience.

The CD reproduction apparatus P of this embodiment is characterized by further having the operation section 15 as a setting device used to set a sound quality range indicated by a quality benchmark for music information on a basis of which the CPU 14 inhibits reproduction.

Accordingly, a user of the CD reproduction apparatus P can set the quality benchmark to suit preferences of the user. For example, the user can set the quality benchmark, on a basis of which poorness of a sound quality is determined, as a reproduction inhibition range, and the CD reproduction apparatus P can inhibit reproduction of music information with a sound quality within a sound quality range indicated by the set quality benchmark. The CD reproduction apparatus P can automatically can reproduce information while skipping a piece of information with a sound quality which the user does not want to target for reproduction. For this reason, the user is free from discomfort caused by seeing or hearing reproduced music information with a poor sound quality. When a piece of information with a poor quality is reproduced, the user need not skip the piece of information and operate to reproduce a next piece of information. The CD reproduction apparatus P is excellent in user convenience.

In the CD reproduction apparatus P of this embodiment, music information is used as information. The information, however, may be at least one of voice and image information.

In reproducing a piece of music serving as voice information, a photo or picture serving as image information, or a footage of a drama or film serving as voice and image information, an information reproduction apparatus of the present invention reproduces the information while automatically skipping a piece of information with a sound quality or image quality which a user does not want to target for reproduction.

The CD reproduction apparatus P of this embodiment is characterized in that a sound quality of music information is at least one of a bit rate and a sampling frequency.

Since the CD reproduction apparatus P inhibits reproduction of music information based on at least one of the bit rate and the sampling frequency which is a typical value indicating the sound quality of music information, it can reproduce music information while automatically skipping a piece of music information with a bit rate which a user does not want to target for reproduction. For this reason, the user is free from discomfort caused by seeing or hearing reproduced music information with a poor sound quality. When a piece of music information with a poor quality is reproduced, the user need not skip the piece of music information and operate to reproduce a next piece of music information. The CD reproduction apparatus P is excellent in user convenience.

The CD reproduction apparatus P is characterized in that the CPU 14 serving as a reproduction inhibition device has a reading function of reading a sound quality of music information from the CD medium DK and a comparison function of comparing the sound quality of the music information read by the reading function with a sound quality range indicated by a quality benchmark, and inhibits reproduction of the music information if the sound quality of the music information falls within the sound quality range indicated by the quality benchmark.

More specifically, since the CPU 14 functions in this manner, it can inhibit reproduction of music information with a sound quality within a sound quality range indicated by a preset quality benchmark. Thus, as described above, a user of the CD reproduction apparatus P is free from discomfort caused by seeing or hearing reproduced music information with a poor sound quality.

The CD reproduction apparatus P of this embodiment is characterized by having the display 16 as a notification device which gives a notice that reproduction of music information inhibited by the CPU 14, from being reproduced is inhibited.

Since the notice that reproduction of the information inhibited from being reproduced is inhibited is given by being displayed on the display 16, a user can recognize which piece of information is inhibited from being reproduced. The CD reproduction apparatus P is excellent in user convenience.

The CD reproduction apparatus P of this embodiment is characterized in that the CPU 14 does not function as a reproduction inhibition device if it is determined based on a quality benchmark indicating whether music information is compressed that all pieces of music information recorded on the CD medium DK are not compressed.

The reproduction inhibition device does not function for a CD medium such as a CDDA (Compact Disc Digital Audio; a music CD) having pieces of uncompressed information recorded thereon, and thus, all the pieces of music information recorded on the CD medium can be reproduced as usual. Since these pieces of music information to be reproduced are not compressed, their sound quality has not degraded A user can reproduce the pieces of music information without feeling discomfort.

The CD reproduction apparatus P of this embodiment is characterized in that if an information quality which the CD reproduction apparatus P can target for reproduction is preset, the CPU 14 serving as a reproduction inhibition device inhibits reproduction of information with a quality other than the preset quality.

Like a conventional CD reproduction apparatus (information reproduction apparatus), the CD reproduction apparatus P can inhibit reproduction of a piece of information with a quality other than the preset quality, i.e., one compressed in a nonstandard format, and can automatically skip reproduction of this piece of information. For this reason, a user is free from discomfort caused by time that the CD reproduction apparatus P takes to perform reading and the like for nonstandard information which cannot be reproduced. When a piece of information with a poor quality is reproduced, the user need not skip the piece of information and operate to reproduce a next piece of information. The CD reproduction apparatus P is excellent in user convenience.

The present invention may be embodied in other specific forms without departing from the spirit or essential characteristics thereof. The present embodiments and examples are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2004-87220 filed on Mar. 24, 2004 including the specification, claims, drawings and summary is incorporated herein by reference in its entirety.

1. An information reproduction apparatus which reproduces information recorded on a recording medium, comprising
a reproduction inhibition device which inhibits reproduction of the information recorded in compressed form based on a preset quality benchmark for a quality of the information.

2. The apparatus according to claim 1, further comprising a setting device used to set a quality range indicated by the quality benchmark for the information inhibited by the reproduction inhibition device, from being reproduced.

3. The apparatus according to claim 1, wherein the information is at least one of voice information and image information.

4. The apparatus according to claim 1, wherein the quality of the information is at least one of a bit rate and a sampling frequency.

5. The apparatus according to claim 1, wherein
the reproduction inhibition device comprises
a reading device which reads the quality of the information from the recording medium, and
a comparison device which compares the quality of the information read by the reading device with the quality range indicated by the quality benchmark, and
the reproduction inhibition device inhibits reproduction of the information if the quality of the information falls within the quality range indicated by the quality benchmark.

6. The apparatus according to claim 1, further comprising a notification device which gives a notice that reproduction of the information inhibited by the reproduction inhibition device, from being reproduced is inhibited.

7. The apparatus according to claim 1, wherein the reproduction inhibition device does not function if it is determined based on the quality benchmark indicating whether the information is compressed that all of pieces of information constituting the information recorded on the recording medium are not compressed.

8. The apparatus according to claim 1, wherein if a quality of the information which the information reproduction apparatus can target for reproduction is preset, the reproduction inhibition device inhibits reproduction of a piece of information with a quality other than the preset quality, out of the information.

9. An information reproduction method for reproducing information recorded on a recording medium, comprising
a reproduction inhibition step of inhibiting reproduction of the information recorded in compressed form based on a preset quality benchmark for a quality of the information.

10. An information reproduction program for causing a computer included in an information reproduction apparatus which reproduces information recorded on a recording medium to function as a reproduction inhibition device which inhibits reproduction of the information recorded in compressed form based on a preset quality benchmark for a quality of the information.

11. An information recording medium having an information reproduction program recorded thereon so as to be readable by a computer included in an information reproduction apparatus which reproduces information recorded on a recording medium, the program causing the computer to function as a reproduction inhibition device which inhibits reproduction of the information recorded in compressed form based on a preset quality benchmark for a quality of the information.
